(19) United States
(12) Patent Application Publication
(10) Pub. No.: US 2006/0019017 A1
(43) Pub. Date: Jan. 26, 2006

(54) Soy protein concentrate with high gel strength and the process for making the same

(76) Inventors: Navpreet Singh, St. Louis, MO (US); Anthony Irwin, Webster Groves, MO (US); John D. Everard, Wilmington, DE (US)

Correspondence Address: SOLAE, LLC, PO BOX 88940, ST LOUIS, MO, 63188, US

(21) Appl. No.: 11/159,747

(22) Filed: Jun. 23, 2005

Related U.S. Application Data
(63) Continuation-in-part of application No. 10/731,181, filed on Dec. 9, 2003.
(60) Provisional application No. 60/431,873, filed on Dec. 9, 2002.

(51) Int. Cl. A23L 1/31

(52) U.S. Cl. 426/574

(57) ABSTRACT

A high gel strength protein material that can be incorporated into food products. The high gel strength protein material may be a protein concentrate having a lard gel strength of at least about 560.0 grams and a protein content of at least about 65.0 wt. % on a moisture free basis. The high gel strength protein concentrate is obtained by removing soluble components from an alcohol washed soy protein concentrate after a pH adjustment to less than 6.0, readjusting the pH to more than 7.0, and subjecting the resulting concentrate to heat treatment and optionally to shearing to form a product, and thereafter optionally drying the resulting product.

CROSS REFERENCE TO RELATED APPLICATIONS

This application claims the benefit under Title 35, U.S.C. § 119(e) of U.S. Provisional Patent Application Ser. No. 60/431,873, entitled SOY PROTEIN CONCENTRATE WITH HIGH GEL STRENGTH AND THE PROCESS FOR MAKING THE SAME, filed on Dec. 9, 2002. This application is also a continuation-in-part patent application of U.S. patent application Ser. No. 10/731,181, entitled SOY PROTEIN CONCENTRATE WITH HIGH GEL STRENGTH AND THE PROCESS FOR MAKING THE SAME, filed on Dec. 9, 2003.

### BACKGROUND OF THE INVENTION

1. Technical Field

The present invention relates to a vegetable protein product that has a high gel strength and a high emulsion strength, and to a process for obtaining such product.

2. Description of the Related Art

Plant protein materials are used as functional food ingredients, and have numerous applications in enhancing desirable characteristics in food products. Soy protein materials, in particular, have seen extensive use as functional food ingredients. Soy protein materials are used as emulsifiers in meats, such as frankfurters, sausages, bologna, ground and minced meats and meat patties, to bind the meat and give the meat a good texture and a firm bite. Another common application for soy protein materials as functional food ingredients is in creamed soups, gravies, and yogurts where the soy protein material acts as a thickening agent and provides a creamy viscosity to the food product. Soy protein materials are also used as functional food ingredients in numerous other food products such as dips, soups, gravies, cereal products, dairy products, tuna products, breads, cakes, macaroni, confections, whipped toppings, baked goods, meat analogs, whole muscle meat products, beef meat products, pork meat products, poultry products, seafood products, and many other applications.

Soy protein concentrates and soy protein isolates, which have relatively high concentrations of protein, are particularly effective functional food ingredients due to the versatility of soy protein. Soy protein provides gelling properties and has been used to modify the texture in ground and emulsified meat products. The texture-modifying gel structure provides dimensional stability to cooked meat emulsions which results in firm texture and desired chewiness. In addition, the gel structure provides a matrix for retaining moisture and fats.

Soy protein also acts as an emulsifier in various food applications since soy proteins are surface active and collect at oil-water interfaces, inhibiting the coalescence of fat and oil droplets. The emulsification properties of soy proteins allow soy protein containing materials to be used to thicken food products such as soups and gravies. The emulsification properties of soy protein materials also permit the soy protein materials to absorb fat and therefore promote fat binding in cooked foods so that “fatting out” of the fat during cooking processes can be limited. Soy protein materials also function to absorb water and retain it in finished food products due to the hydrophilic nature of the numerous polar side chains along the peptide backbone of soy proteins. The moisture retention of a soy protein material may be utilized to decrease cooking loss of moisture in a meat product, providing a yield gain in the cooked weight of the meat product. The retained water in the finished food products is also useful for providing a more tender mouthfeel to the product.

Soy protein based meat analog products or gelling food products, for example cheese and yogurt, offer many health benefits to consumers. Consumer acceptance of these products is directly related to organoleptic qualities such as texture, flavor, mouthfeel and appearance. Protein sources for gel-based food products such as meat analogs advantageously have good gel forming properties at relatively low cooking temperatures and good water and fat binding properties.

Both the strength of a gel and how it affects a final product into which it is to be incorporated are important considerations in determining the usefulness of a gel. The emulsification strength of a material is also an important characteristic to be considered in incorporating a material into a food product. As discussed above, the functionality of soy protein gels in food products and the emulsification properties of soy protein materials in food products have been well established.

Gel strengths of soy protein materials such as soy protein concentrates and soy protein isolates vary, and there is always a need for improvements in the gel strength of soy protein concentrates and isolates. Emulsification strengths of soy protein materials such as soy protein concentrates and soy protein isolates also vary, and there is always a need for improvements in the emulsification strength of soy protein materials such as soy protein concentrates and soy protein isolates. Especially desirable, particularly for use in emulsified meat products, are soy protein materials such as soy protein concentrates and soy protein isolates that have both strong gelling properties and strong emulsification properties.

### SUMMARY OF THE INVENTION

The present invention provides a soy protein material composition that is characterized by having a lard gel strength of at least 560.0 grams. In a preferred embodiment, the soy protein concentrate composition has a lard gel strength of greater than about 575.0 grams. In one embodiment, the soy protein material composition is a soy protein concentrate composition having a lard gel strength of at least 560.0 grams and having a protein content of from 65.0 wt. % to 85.0 wt. % of total matter on a moisture free basis (“mfb”). In another embodiment, the soy protein material composition is a soy protein isolate composition having a lard gel strength of at least 560.0 grams and having a protein content of at least 90 wt. % of total matter on a moisture free basis.

In another aspect, the present invention provides a soy protein material composition having an uncooked emulsification strength of at least 190 grams. In a preferred embodiment, the soy protein material composition has an uncooked emulsification strength of at least 225 grams. In one embodiment, the soy protein material is a soy protein concentrate composition having an uncooked emulsification strength of at least 190 grams and having a protein content of from 65.0 wt. % to 85.0 wt. % of total matter on a moisture free basis (“mfb”). In another embodiment, the soy protein material is a soy protein isolate composition having an uncooked emulsification strength of at least 190 grams and having a protein content of at least 90 wt. % of total matter on a moisture free basis.

In a further aspect, the present invention provides a soy protein material composition having a cooked emulsification strength of at least 275 grams. In a preferred embodiment, the soy protein material composition has a cooked emulsification strength of at least 300 grams. In one embodiment, the soy protein material is a soy protein concentrate composition having a cooked emulsification strength of at least 275 grams and having a protein content of from 65.0 wt. % to 85.0 wt. % of total matter on a moisture free basis (“mfb”). In another embodiment, the soy protein material is a soy protein isolate composition having a cooked emulsification strength of at least 275 grams and having a protein content of at least 90 wt. % of total matter on a moisture free basis.

In yet another aspect, the present invention is a food material that contains a soy protein material having a lard gel strength of at least 560.0 grams, or an uncooked emulsion strength of at least 190.0 grams, or a cooked emulsion strength of at least 275 grams. The soy protein material composition of the present invention is capable of being incorporated into numerous food products including, but not limited to, dips, soups, gravies, cereal products, dairy products, tuna products, breads, cakes, macaroni, confections, whipped toppings, baked goods, meat analogs, whole muscle meat products, beef meat products, pork meat products, poultry products, seafood products, and many other applications.

The present invention also relates to a process to obtain a soy protein material composition that demonstrates a high lard gel strength and a high uncooked and cooked emulsification strength. The process involves mixing or slurrying an alcohol washed soy protein concentrate with water, adjusting the pH of the slurry to less than 6.0, removing soluble components from the slurry, readjusting the pH to at least 7.0, subjecting the resulting slurry to heat treatment such as jet cooking, and optionally shearing, to change the protein structure, and thereafter optionally drying the resulting product.

The present invention also relates to soy protein concentrates having a soy protein concentration of greater than 75% and less than 90% by weight on a moisture free basis that comprise a very low level of volatile compounds that can negatively affect taste. The soy protein concentrates have excellent functional properties and present a bland taste making them highly suitable for use in a number of foods and drink products including, for example, dry blended beverages, ready to drink neutral beverages, ready to drink acid beverages, yogurt, food and protein bars, emulsified meat products, whole muscle meat products, meat analogs, ground meat products, and the like. Meat products may include beef, pork, poultry, and seafood.

As such, the present invention is directed to a soy protein concentrate comprising less than about 0.5 ppb 3-methyl butanal and greater than 75% and less than 90% protein content by weight on a moisture free basis.

The present invention is further directed to a soy protein concentrate comprising less than about 10 ppb pentanal and greater than 75% and less than 90% protein content by weight on a moisture free basis.

The present invention is further directed to a soy protein concentrate comprising less than about 25 ppb hexanal and greater than 75% and less than 90% protein content by weight on a moisture free uasis.

The present invention is further directed to a soy protein concentrate comprising less than about 1 ppb 1-octen-3-ol and greater than 75% and less than 90% protein content by weight on a moisture free basis.

The present invention is further directed to a soy protein concentrate comprising less than about 1 ppb 2-pentyl furan and greater than 75% and less than 90% protein content by weight on a moisture free basis.

The present invention is further directed to a soy protein concentrate comprising less than about 2.5 ppb (E) 3-octen-2-one and greater than 75% and less than 90% protein content by weight on a moisture free basis.

The present invention is further directed to a soy protein concentrate comprising less than about 0.2 ppb (E) 2-octenal and greater than 75% and less than 90% protein content by weight on a moisture free basis.

The present invention is further directed to a soy protein concentrate comprising less than about 0.5 ppb 3-methyl butanal, wherein the soy protein concentrate comprises greater than 75% protein and less than 90% protein content by weight on a moisture free basis, and wherein the soy protein concentrate is prepared from a method comprising first slurrying an alcohol washed soy protein material in water and adjusting the pH of the slurry to an acid pH of less than 6.0. Thereafter, soluble components are removed from the acid pH slurry and the pH adjusted to above 7.0 to provide a neutralized slurry. Finally, the neutralized slurry is subjected to heat treatment at a sufficient temperature and for a sufficient period of time to change the structure of the soy protein material.

### BRIEF DESCRIPTION OF THE DRAWINGS

FIG. 1 is a representation of a suitable headspace apparatus for use in Gas-Chromatography-Mass Spectrometry analysis as described herein.

### DETAILED DESCRIPTION

### DEFINITIONS

As used herein, the term “soy material” is defined as a material derived from whole soybeans which contains no non-soy derived additives. Such additives may, of course, be added to a soy material to provide further functionality either to the soy material or to a food in which the soy material is utilized as a food ingredient. The term “soybean” refers to the species Glycine max, Glycine soja, or any species that is sexually cross compatible with Glycine max.

As used herein, the term “soy protein material” refers to a soy protein containing material that contains at least 40% soy protein by weight on a moisture-free basis.

As used herein, the term “soy protein concentrate” refers to soy protein containing material that contains from 65% up to 90% soy protein by weight on a moisture free basis.

As used herein, the term “soy protein isolate” refers to a soy protein containing material that contains at least 90% soy protein by weight on a moisture free basis.

As used herein, the term “lard gel strength” refers to the gel strength of a soy protein material in a mixture of water and lard. The lard gel strength of a soy protein material may be determined by the following method. First, soy protein gels are made from a soy protein material sample as follows. 634.0 grams of 0° C. (32° F.) water is placed in a Stephan Vertical-Cutter/Mixer (Model No. UM-5, Stephan Machinery Corporation, Columbus, Ohio). 141.0 grams of the soy protein material sample is added to the cutter/mixer. A vacuum is applied to the cutter/mixer and the chopper is slowly started to prevent splattering. The sample protein material is vacuum chopped for 2 minutes at 900 revolutions per minute (rpm), while the stirring arm is moved every 30 seconds in both directions. Thereafter, the applied vacuum is terminated and the lid and sides of the bowl are scraped. 200.0 grams of room temperature lard is added to the bowl of the cutter/mixer together with 20.0 grams of salt and 5.0 grams of sodium tripolyphosphate. A vacuum is again applied to the cutter/mixer and its contents are chopped for 1 minute at 1200 rpm while the stirring arm is constantly moved in both directions. The vacuum is temporarily released and the lid and sides of the bowl are scraped. The vacuum is reapplied and the contents of the bowl are chopped for an additional 2 minutes at 1200 rpm while moving the stirring arm every 30 seconds in both directions. The target temperature for gel strength measurements according to this procedure is about 16°-18° C. (60°-65° F.).

The contents of the bowl are emptied out into a 10″×16″ vacuum bag. A vacuum is applied to the bag for 30 seconds prior to heat sealing the bag. Using the vacuum bag, the test sample is placed in sausage stuffer and stuffed into four #202 metal cans. A concave surface is scraped into the face of the test samples in the cans with a spatula, and a lid is placed on the cans. The cans are sealed with the lids and steam cooked for 20 minutes at 60° C. (140° F.), 20 minutes at 71° C. (160° F.), and 20 minutes at 79° C. (175° F.) to an internal temperature of 73° C. (165° F.). The cans are left to cool at room temperature overnight before running texture analysis.

The textural quality of the gels is evaluated visually and instrumentally using a TA-XT2 Texture Analyzer (Texture Technologies Corporation, Scarsdale, N.Y.). The texture analyzer is equipped with a 12.5 millimeter spherical probe. All samples to be tested are equilibrated at room temperature before texture analysis. To test the samples, the bottoms of the cans are opened; however, the samples are not removed from the cans. The spherical probe of the texture analyzer is allowed to penetrate the gel samples until peak force applied to the probe to push it into the gel samples is reached. Four measurements per can are taken at locations between the center and the perimeter of the can. No measurement is taken at the center of the cans. The measurements are repeated with another can of the same sample from the cutter/mixer to provide a total of eight measurements for two cans.

Lard gel strength according to the present invention is the measured peak force in grams of the probe as it is pushed into the canned gel samples. The measured peak force is determined from a graph produced by the texture analyzer, where the lard gel strength is measured at the point at which the gel is broken by the probe (the first large peak on the graph, where the graph's X axis is time and the graph's Y axis is force in grams). For accuracy, lard gel strength is reported herein as an average of eight measurements.

As used herein, the term “uncooked emulsification strength” refers to strength of an emulsion formed by a soy protein material in a soybean oil and water mixture, where the emulsion is not cooked prior to testing its emulsification strength. The emulsion strength of such an emulsion may be determined by the following method. First, an emulsion is prepared of the soy protein material sample. 880 grams of soybean oil having a temperature of from 17° C. to 23° C. (63°-73° F.) is weighed into a tared beaker. The soybean oil is then poured into the chopper bowl of a Hobart Food Cutter (Model 84142 or 84145, 1725 rpm shaft speed). 220 grams of a soy protein material sample is then dispersed over the surface of the soybean oil in the chopper bowl of the food cutter, and the food cutter and a timer are started. Immediately after the food cutter is started, 1100 milliliters of deionized water is added to the mixture of soybean oil and soy protein material in the chopper bowl of the cutter, and the food cutter lid is closed after the water is added. After 1 minute, the food cutter and timer are stopped, the lid of the food cutter is opened, and the inside of the lid is thoroughly scraped with a rubber spatula. The lid is then reclosed and the food cutter and timer are then restarted. 44 grams of salt is added to the mixture in the chopper bowl of the food cutter four minutes after restarting the food cutter. After 5.5 minutes of total chop time, the cutter and timer are stopped and the lid is rescraped as described above, followed by restarting the food cutter and timer. After 7 minutes of total chopping time, the food cutter is stopped and 5 fluid ounce samples of an emulsion are retrieved from the emulsion ring of the food cutter in 5 fluid ounce sample cups. The sample cups are then inverted onto a flat tray made from non-absorbing material covered with plastic film and are refrigerated at 2° C. to 7° C. (36°-45° F). 24 to 30 hours after refrigeration the sample cups are carefully removed from the chilled emulsions in each sample cup.

The emulsion strength of the chilled emulsions are immediately measured using a TA-XT2I Texture Analyzer with a gel tester probe (available from Texture Technologies Corp., Scarsdale, N.Y.) that is equipped with a Chatillion Dietary Scale (#R026, 500 grams capacity). The force of the texture analyzer is calibrated using a 5 kilogram weight, and the gel probe is calibrated to a return distance of 75 millimeters and a contact force of 1 gram. The emulsion strength of each chilled emulsion is measured by punching the gel probe of the texture analyzer at a speed of 0.8 millimeters/second and a force of 10 grams into the chilled emulsion at a point equidistant from the center of the emulsion and the edge of the emulsion until the probe punctures the emulsion. Three measurements of emulsion strength are taken per sample at equidistant points from each other (no measurements are taken at the center of the emulsion sample), and measurements are taken of three emulsion samples for a total of nine measurements.

The uncooked emulsification strength (in grams of force) is the measured peak force in grams of the probe as it is pushed into the uncooked emulsion. The measured peak force is determined from a graph produced by the texture analyzer, where the uncooked emulsification strength is measured at the point at which the emulsion is broken by the probe (the first large peak on the graph, where the graph's X axis is time and the graph's Y axis is force in grams). For accuracy, uncooked emulsification strength as used herein is reported as an average of nine measurements.

As used herein, the term “cooked emulsification strength” refers to strength of an emulsion formed by a soy protein material in a soybean oil and water mixture, where the emulsion is cooked prior to testing its emulsification strength. The emulsion strength of such an emulsion may be determined by first forming an emulsion of a soy protein material, soybean oil, and deionized water as described above with respect to measuring uncooked emulsification strength up to the point of completing the chopping in the food cutter. The inside of three 307×109 cans are sprayed with a non-stick cooking spray, and the cans are filled with emulsion retrieved from the emulsion ring of the food cutter. Excess emulsion is scraped off the top of the can with a stainless steel spatula leaving a smooth even emulsion surface at the top of the can. The cans are then sealed with a can lid sprayed with non-stick cooking spray using a can seamer.

The sealed cans are cooked in a boiling water bath for 30 minutes. The cans are then removed from the boiling water bath and chilled in an ice water bath for 15 minutes. The chilled cans are then refrigerated at 2° C. to 7° C. (36°-45° F.) for a period of 20 to 32 hours. The lids of the cans are then removed to expose the cooked chilled emulsion.

The emulsion strength of the cooked chilled emulsions are immediately measured using a TA-XT2I Texture Analyzer with a gel tester probe (available from Texture Technologies Corp., Scarsdale, N.Y.) that is equipped with a Chatillion Dietary Scale (#R026, 500 grams capacity). The force of the texture analyzer is calibrated using a 5 kilogram weight, and the gel probe is calibrated to a return distance of 45 millimeters and a contact force of 1 gram. The emulsion strength of each chilled emulsion is measured by punching the gel probe of the texture analyzer at a speed of 0.8 millimeters/second and a force of 10 grams into the chilled emulsion at a point equidistant from the center of the emulsion and the edge of the emulsion until the probe punctures the emulsion. Three measurements of emulsion strength are taken per can of emulsion at equidistant points from each other, and measurements are taken of the three emulsion samples for a total of nine measurements.

The cooked emulsification strength (in grams of force) is the measured peak force in grams of the probe as it is pushed into the cooked emulsion. The measured peak force is determined from a graph produced by the texture analyzer, where the cooked emulsification strength is measured at the point at which the emulsion is broken by the probe (the first large peak on the graph, where the graph's X axis is time and the graph's Y axis is force in grams). For accuracy, cooked emulsification strength as used herein is reported as an average of nine measurements.

The term “protein content” as used herein, refers to the relative protein content of a soy material as ascertained by A.O.C.S. (American Oil Chemists Society) Official Methods Bc 4-91(1997), Aa 5-91(1997), or Ba 4d-90(1997); each incorporated herein in its entirety by reference, which determine the total nitrogen content of a soy material sample as ammonia, and the protein content as 6.25 times the total nitrogen content of the sample. The Nitrogen-Ammonia-Protein Modified Kjeldahl Method of A.O.C.S. Methods Bc4-91 (1997), Aa 5-91 (1997), and Ba 4d-90(1997) used in the determination of the protein content may be performed as follows with a soy material sample. 0.0250-1.750 grams of the soy material are weighed into a standard Kjeldahl flask. A commercially available catalyst mixture of 16.7 grams potassium sulfate, 0.6 grams titanium dioxide, 0.01 grams of copper sulfate, and 0.3 grams of pumice is added to the flask, then 30 milliliters of concentrated sulfuric acid is added to the flask. Boiling stones are added to the mixture, and the sample is digested by heating the sample in a boiling water bath for approximately 45 minutes. The flask should be rotated at least 3 times during the digestion. 300 milliliters of water is added to the sample, and the sample is cooled to room temperature. Standardized 0.5N hydrochloric acid and distilled water are added to a distillate receiving flask sufficient to cover the end of a distillation outlet tube at the bottom of the receiving flask. Sodium hydroxide solution is added to the digestion flask in an amount sufficient to make the digestion solution strongly alkaline. The digestion flask is then immediately connected to the distillation outlet tube, the contents of the digestion flask are thoroughly mixed by shaking, and heat is applied to the digestion flask at about a 7.5-min boil rate until at least 150 milliliters of distillate is collected. The contents of the receiving flask are then titrated with 0.25N sodium hydroxide solution using 3 or 4 drops of methyl red indicator solution—0.1% in ethyl alcohol. A blank determination of all the reagents is conducted simultaneously with the sample and similar in all respects, and correction is made for blank determined on the reagents. The moisture content of the ground sample is determined according to the procedure described below (A.O.C.S Official Method Ba 2a-38). The nitrogen content of the sample is determined according to the formula: Nitrogen (%)=1400.67×[[(Normality of standard acid)×(Volume of standard acid used for sample (milliliters))]−[(Volume of standard base needed to titrate 1 milliliter of standard acid minus volume of standard base needed to titrate reagent blank carried through method and distilled into 1 ml standard acid (milliliter))×(Normality of standard base)]−[(Volume of standard base used for the sample (milliliters))×(Normality of standard base)]]/(Milligrams of sample). The protein content is 6.25 times the nitrogen content of the sample.

The term “moisture content” as used herein refers to the amount of moisture in a material. The moisture content of a soy material can be determined by A.O.C.S. (American Oil Chemists Society) Method Ba 2a-38 (1997), which is incorporated herein by reference in its entirety. According to the method, the moisture content of a soy material may be measured by passing a 1000 gram sample of the soy material through a 6×6 riffle divider, available from Seedboro Equipment Co., Chicago, Ill., and reducing the sample size to 100 grams. The 100 gram sample is then immediately placed in an airtight container and weighed. 5 grams of the sample are weighed onto a tared moisture dish (minimum 30 gauge, approximately 50×20 millimeters, with a tight-fitting slip cover—available from Sargent-Welch Co.). The dish containing the sample is placed in a forced draft oven and dried at 130±3° C. (261°-271° F.) for 2 hours. The dish is then removed from covered immediately, and cooled in a dessicator to room temperature. The dish is then weighed. Moisture content is calculated according to the formula: Moisture content (%)=100×[(loss in mass (grams)/mass of sample (grams)].

The term “soy flour” as used herein means a soy protein material that is particulate and contains less than 65% soy protein content by weight on a moisture free basis which is formed from dehulled soybeans and which has an average particle size of 150 microns or less. A soy flour may contain fat inherent in soy or may be defatted.

The term “soy grit” as used herein means a soy protein material that is particulate and contains less than 65% soy protein content by weight on a moisture free basis which is formed from dehulled soybeans and which has an average particle size of from 150 microns to 1000 microns. A soy grit may contain fat inherent in soy or may be defatted.

The term “soy meal” as used herein means a soy protein material that is particulate and contains less than 65% soy protein content by weight on a moisture free basis which is formed from dehulled soybeans which does not fall within the definition of a soy flour or a soy grit. The term soy meal is intended to be utilized herein as a catchall for particulate soy protein containing materials having less than 65% protein on a moisture free basis which do not fit the definition of a soy flour or a soy grit. A soy meal may contain fat inherent in soy or may be defatted.

The term “soy flakes” as used herein means a soy protein material that is a flaked soy material containing less than 65% soy protein content by weight on a moisture free basis formed by flaking dehulled soybeans. Soy flakes may contain fat inherent in soy or may be defatted.

The term “weight on a moisture free basis” as used herein refers to the weight of a material after it has been dried to completely remove all moisture, e.g. the moisture content of the material is 0%. Specifically, the weight on a moisture free basis of a soy material can be obtained by weighing the soy material after the soy material has been placed in a 45° C. (113° F.) oven until the soy material reaches a constant weight.

The term “nitrogen solubility index” as used herein is defined as: (% water soluble nitrogen of a protein containing sample/% total nitrogen in protein containing sample)×100. The nitrogen solubility index provides a measure of the percent of water soluble protein relative to total protein in a protein containing material. The nitrogen solubility index of a soy material is measured in accordance with standard analytical methods, specifically A.O.C.S. Method Ba 11-65, which is incorporated herein by reference in its entirety. According to the Method Ba 11-65, 5 grams of a soy material sample ground fine enough so that at least 95% of the sample will pass through a U.S. grade 100 mesh screen (average particle size of less than about 150 microns) is suspended in 200 milliliters of distilled water, with stirring at 120 rpm, at 30° C. (86° F.) for two hour is diluted to 250 milliliters with additional distilled water. If the soy material is a full-fat material the sample need only be ground fine enough so that at least 80% of the material will pass through a U.S. grade 80 mesh screen (approximately 175 microns), and 90% will pass through a U.S. grade 60 mesh screen (approximately 205 microns). Dry ice should be added to the soy material sample during grinding to prevent denaturation of the sample. 40 milliliters of the sample extract is decanted and centrifuged for 10 minutes at 1500 rpm, and an aliquot of the supernatant is analyzed for Kjeldahl protein to determine the percent of water soluble nitrogen in the soy material sample according to A.O.C.S Official Methods Bc 4-91 (1997), Ba 4d-90, or Aa 5-91, as described above. A separate portion of the soy material sample is analyzed for total protein to determine the total nitrogen in the sample. The resulting values of Percent Water Soluble Nitrogen and Percent Total Nitrogen are utilized in the formula above to calculate the Nitrogen Solubility Index.

The total amount of potassium in a soy protein isolate and other elements as reported herein can be measured using an Inductively Coupled Plasma (ICP) Mineral Screen according to the Official Methods of Analysis of the AOAC International, 16th Edition, Method 965.09, Locator 2.6.01 (Modified). In addition to potassium, this method also measures total amount of calcium, cobalt, copper, iron, magnesium, manganese, sodium, phosphorus, and zinc in a soy protein isolate.

The ICP method includes taking a 5.0 gram sample of the soy protein concentrate, placing the sample into a weighed crucible and heating the sample in the weighed crucible on a hot plate set on high until the sample is charred and the smoking ceases. The crucible containing the charred sample is then placed in a pre-heated muffle furnace set at 500° C. and the sample is ashed to remove organic material by heating for a minimum of 6 hours, but typically heating for about 16 hours to form a white ash residue. 10 milliliters of 3N HCl is then added to the white ash residue in the crucible to form an acidic slurry, which is then heated on a hot plate for 15-20 minutes to solublize the minerals in the ash. The hot acidic slurry is then transferred to a 100 milliliter volumetric flask and allowed to cool to room temperature. After cooling, a sufficient amount of de-ionized water is added to the acidic slurry to fill the volumetric flask to 100 milliliters. The concentration of potassium as well as calcium, cobalt, copper, iron, magnesium, manganese, sodium, phosphorus, and zinc are determined by comparing the emission of the unknown sample to the emissions of standard solutions, measured by inductively coupled plasma atomic emission spectroscopy. The lowest confidence levels for this method are as follows: Potassium, 400 ppm; Calcium, 1000 ppm; Cobalt, 20 ppm; Copper, 4 ppm; Iron, 100 ppm; Magnesium, 200 ppm; Manganese, 20 ppm; Sodium, 400 ppm; Phosphorus 1000 ppm; Zinc, 100 ppm.

The total amount of ash in the soy protein concentrate is measured using ash according to the ASTM, Part 15, pp. 621-622, D 1797-62 “Ash in Casein and Isolated Soy Protein.” This method includes first taking a sample of the soy protein concentrate weighing between 1.0-3.0 gram(s) and placing it into a tared crucible. The sample in the weighed crucible is then heated on a hot plate set on high until sample is charred and the smoking ceases. The crucible containing the charred sample is then placed in a pre-heated muffle furnace set at 800° C. and the sample is ashed to remove organic material by heating for 2 hours. The crucible is then removed and allowed to cool to 100-200° C. The crucible is then transferred to a dessicator and allow to cool to room temperature. Finally, it is weighed and the weight recorded. The % Ash is calculated using the following formula:
% Ash=(100)(G−T)/S
Where G=Gross weight of crucible, g
T=Tare weight of crucible, g
100=Conversion factor to %
S=Sample weight
   Method

The soy protein material composition of the present invention is obtained by a method which generally includes the steps of providing an alcohol washed soy protein material, preferably an alcohol washed soy protein concentrate; mixing or slurrying an amount of the alcohol washed soy protein concentrate with water to obtain an aqueous slurry containing between 1.0 and 15.0 wt. % solids; adjusting the pH of the slurry to less than 6.0; removing soluble components while retaining proteins in the slurry; adjusting the pH of the slurry to a pH of 7.0 or greater; subjecting the pH-adjusted slurry to heat treatment at a temperature of from 75° C. to 180° C. (156°-356° F.), such as jet cooking at high temperature; optionally shearing the heated slurry; and optionally drying the slurry.

The starting material of the present process is an alcohol washed soy protein concentrate. Alcohol washed soy protein concentrates, sometimes known in the art as “traditional” soy protein concentrates, are commercially available from many sources. One alcohol washed soy protein concentrate which is suitable as a starting material for the present invention is Procon® 2000, which is available from The Solae Company of St. Louis, Mo. Another suitable commercially available alcohol washed soy protein concentrate is Danpro™ H, also available from The Solae Company.

It is to be understood that rather than use a commercially available alcohol washed soy protein concentrate as the starting material in the present invention, the starting material can be soy flour, soy grits, soy meal, or soy flakes from which an alcohol washed soy protein concentrate can be produced by washing the soy flour, soy grits, soy meal, or soy flakes with a low molecular weight aqueous alcohol, preferably aqueous ethanol, followed by desolventizing the alcohol washed soy protein material. Soy flour, soy grits, soy meal, or soy flakes are commercially available, or, alternatively, may be produced from soybeans according to processes well known in the art. The thus produced alcohol washed soy protein concentrate can then be used in the process as described herein.

The alcohol washed soy protein concentrate is first slurried with water at a solids content of from 1.0 wt. % to 15.0 wt. %. Preferably, the alcohol washed soy protein concentrate is slurried with water at a solids content of from 1.0 wt. % to 10.0 wt. %. The water used to slurry the soy protein concentrate is preferably heated to a temperature of 27° C. to 82° C.(80°-180° F.). A temperature of 49° C. (120° F.) was found to be particularly suitable for purposes of the present invention.

The pH of the slurry is adjusted to less than 6.0 in order to solubilize the minerals in the slurry while minimizing protein solubility to facilitate removal of the minerals and other undesirable components in a subsequent separation process, as described below. In a preferred embodiment, the pH is adjusted to between 4.3 and 5.3, preferably between 5.0 and 5.2, or, to about the isoelectric point of soy protein which is between pH 4.4 and 4.6. The pH of the slurry can be adjusted by addition of hydrochloric acid or other suitable edible organic or inorganic acids.

After pH adjustment, the slurry is subjected to a separation process to remove undesirable components such as carbohydrates, isoflavones, minerals, and volatile off-flavors. Suitable processes for removing undesirable components include centrifugation, ultrafiltration and other conventional separation processes. The undesirable components separation step is particularly important to produce the high lard gel strength, high emulsification strength soy protein material of the present invention, and is particularly unexpected to significantly affect the characteristics of an alcohol washed soy protein concentrate. Alcohol washing to produce the alcohol washed soy protein removes large amounts of “soy solubles”. As such, it is unexpected that further removal of undesirable components would affect the characteristics of a soy protein material already washed with alcohol since it would be expected that the alcohol wash would have removed a large majority of such undesirable components.

According to one embodiment of the present invention, the slurry is subjected to an ultrafiltration separation process using a membrane having a molecular weight cut off (“MWCO”) between 10,000 to 1,000,000, and preferably a MWCO of about 50,000. A tubular membrane was determined to be particularly suitable for production of the soy protein concentrate of the present invention. Tubular membranes of different MWCO are commercially and readily available. Some of the vendors are Koch Membrane Systems, Wilmington, Mass.; PTI Advanced Filtration, Oxnard, Calif.; and PCI Membrane Systems, Milford, Ohio. The soluble components are permeated through the membrane as permeate, and proteins are retained by the membrane as retentate.

According to another embodiment, the slurry is subjected to a centrifugation separation process. A preferred centrifuge is a decanting centrifuge. The undesirable components are removed in the liquor fraction, while insoluble materials such as the soy protein are retained in the insoluble cake of the centrifuge. Optionally, the centrifuge process may be repeated one or more times, in which the centrifuge cake of a first centrifugation is diluted with water and then is centrifuged again.

In a preferred embodiment of the centrifuge separation process, the liquor (soluble fraction) of the centrifuge may be further processed using a spiral-wound membrane to recover insoluble proteins in the retentate while removing undesirable components in the permeate. The liquor is subjected to ultrafiltration using a membrane having a molecular weight cut off (MWCO) between 1,000 to 30,000, and preferably a MWCO of about 10,000. A spiral-would membrane was determined to be particularly suitable for the recovery of proteins from the liquor. Spiral-wound membranes of different MWCO are commercially and readily available. Some of the vendors are Koch Membrane Systems, Wilmington, Mass.; GE Osmonics, Minnetonka, Minn.; PTI Advanced Filtration, Oxnard, Calif.; and Synder Filtration, Vacaville, Calif.

The slurry retained after removing the undesirable components by the above separation processes is increased in protein content and has a reduced ash content due to removal of the minerals. This slurry is the retentate when a membrane process is used; a centrifuge cake when a centrifugation process is used; or a composite of centrifuge cake and membrane retentate when a centrifugation process is used followed by a membrane process to recover proteins. If a centrifugation process is used, the centrifuge cake or the composite of centrifuge cake and membrane retentate are diluted to make slurry of from 7.0 wt. % to 20 wt. % solids, preferably from 10.0 wt. % to 15.0 wt. % solids, and most preferably from 12 wt. % to 13 wt. % solids.

After removing the undesirable components, the pH of the slurry is adjusted to 7.0 or more in order to neutralize the slurry, thereby increasing the solubility of the protein in the slurry. In one embodiment, the pH is adjusted to a pH of from 7.0 to 7.5, where pH 7.2 has been found to be particularly suitable. The pH of the slurry can be adjusted by addition of any suitable organic or inorganic base, preferably sodium hydroxide.

To produce a soy protein concentrate composition in accordance with the present invention, the resulting pH adjusted slurry is subjected to a heat treatment or cooking process, and optionally to a shearing process, to change the protein structure and to yield a final product that can optionally be dried.

The heat treatment or cooking process and the optional shearing process changes the structure of the protein to improve the functionality of the protein, producing a product that has high gel strength. Although any cooking process or apparatus can be used provided the soy protein material is subjected to sufficient heat for a sufficient period of time to change the structure of the soy protein material, jet cooking is deemed to be particularly suitable for commercial production of the soy protein concentrate of the present invention. Preferably the neutralized slurry of soy protein material is treated at a temperature of from about 75° C. to about 180° C. (167°-356° F.) for a period of from about 2 seconds to about 2 hours to change the structure of the soy protein in the soy protein material, where the soy protein material slurry is heated for a longer time period at lower temperatures to change the structure of the soy protein in the soy protein material. Preferably, the neutralized slurry is heat treated at a temperature of from 135° C. to 180° C. (275°-356° F.) for a period of 5 to 30 seconds, and most preferably the slurry is heat treated at a temperature of from 145° C. to 155° C. (293°-311° F.) for a period of from 5 to 15 seconds. Most preferably the soy protein material slurry is treated at an elevated temperature and under a positive pressure greater than atmospheric pressure.

As noted above, the preferred method of heat treating the soy protein material slurry is jet-cooking, which consists of injecting pressurized steam into the slurry to heat the slurry to the desired temperature. The following description is a preferred method of jet-cooking the soy protein material slurry, however, the invention is not limited to the described method and includes any obvious modifications which may be made by one skilled in the art.

The soy protein material slurry is introduced into a jet-cooker feed tank where the soy protein material is kept in suspension with a mixer which agitates the soy protein material slurry. The slurry is directed from the feed tank to a pump that forces the slurry through a reactor tube. Steam is injected into the soy protein material slurry under pressure as the slurry enters the reactor tube, instantly heating the slurry to the desired temperature. The temperature is controlled by adjusting the pressure of the injected steam, and preferably is from about 75° C. to about 180° C.(167°-356° F.), more preferably from about 135° C. to 180° C. (275°-356° F.).

After jet cooking, the slurry is held at a high temperature for a period of from 5 seconds to 240 seconds. A total holding time of from 30 seconds to 180 seconds is particularly suitable for the purposes of the present invention.

After cooking, preferably prior to holding the slurry at high temperature, the slurry is optionally subjected to a shearing process to further change the structure of the proteins. Any suitable shearing equipment can be used such as shearing pumps, shearing mixers, or cutting mixers. One suitable shear pump is a Dispax Reactor dispersing pump with three stages (IKA Works, Wilmington, N.C.). These pumps may be equipped with coarse, medium, fine and superfine generators. Each generator consists of a stator and a rotor. A preferred embodiment is to use two fine generators and a superfine generator in the three stages of the pump. Another suitable pump is a high pressure homogenizer. Other shear pumps are commercially available from Fristam Pumps Inc., Middleton, Wis. and Waukesha Cherry-Burrell, Delavan, Wis.

After cooking, optionally shearing the soy protein material, and holding the heated slurry at a high temperature, the slurry is then cooled. Preferably the slurry is flash cooled to a temperature of from 60° C. to 93° C. (140° F.-200° F.), and most preferably flash cooled to a temperature of from 80° C. to 90° C. (176°-194° F.). The slurry is flash cooled by introducing the heated slurry into a vacuumized chamber having a cooler internal temperature than the temperature used to heat treat the soy protein material slurry and having a pressure significantly less than atmospheric pressure. Preferably the vacuum chamber has an internal temperature of from 15° C. to 85° C. (59°-185° F.) and a pressure of from about 25 mm to about 100 Hg, and more preferably a pressure of from about 25 mm Hg to about 30 mm Hg. Introduction of the heated soy protein material slurry into the vacuum chamber instantly drops the pressure around the soy protein material slurry causing vaporization of a portion of the water from the slurry thereby cooling the slurry.

Flash cooling is the preferred cooling process, although it may be replaced by any other suitable cooling process which is capable of reducing the temperature to about 140-200° F. (60-93° C.) in a short period of time.

The cooled slurry of soy protein material may then be dried to produce the powdered soy protein concentrate composition of the present invention. The cooled slurry is preferably spray-dried to produce the soy protein material composition of the present invention. The spray-dry conditions should be moderate to avoid further denaturing of the soy protein in the soy protein material. Preferably the spray-dryer is a co-current flow dryer where hot inlet air and the soy protein material slurry, atomized by being injected into the dryer under pressure through an atomizer, pass through the dryer in a co-current flow. The soy protein in the soy protein material is not subject to further denaturation since the evaporation of water from the soy protein material cools the material as it dries.

In a preferred embodiment, the cooled slurry of soy protein material is injected into the dryer through a nozzle atomizer. Although a nozzle atomizer is preferred, other spray-dry atomizers, such as a rotary atomizer, may be utilized. The slurry is injected into the dryer under enough pressure to atomize the slurry. Preferably the slurry is atomized under a pressure of about 3000 psig to about 4000 psig, and most preferably about 3500 psig.

Although spray-drying the soy protein material is the preferred method of drying, drying may be carried out by any suitable process. Tunnel drying, for example, is another suitable method for drying the soy protein material.

Alternatively, a soy protein isolate composition may be produced in accordance with the present invention. Preferably the soy protein isolate is produced by separating soluble soy protein materials from insoluble materials (such as soy fiber) from the cooled slurry prior to drying the slurry. The cooled slurry is agitated in a mixer to maximize the solubility of the soy protein in the liquid portion of the slurry. The liquid portion of the slurry is then separated from the insoluble portion of the slurry to form a soy protein material containing extract. The liquid portion of the slurry may be separated from the insoluble portion of the slurry by conventional separation means such as centrifugation, filtration, and ultrafiltration. Most preferably, the soy protein containing extract is separated from insolubles using centrifugation. After the soy protein containing extract is separated from the insolubles, the extract is dried as described above to produce a soy protein isolate composition in accordance with the present invention.

A soy protein isolate composition may also be produced by separating a soy protein containing extract from soy insolubles in the neutralized slurry after removing the solubles at acid pH and prior to heat treating the material. The neutralized slurry is agitated to maximize solubility of the soy protein in the liquid portion of the slurry. The soy protein containing liquid portion of the slurry is then separated from the insoluble portion of the slurry to form a soy protein material containing extract. The liquid portion of the slurry may be separated from the insoluble portion of the slurry by conventional separation means such as centrifugation, filtration, and ultrafiltration. Most preferably, the soy protein material containing extract is separated from insolubles by centrifugation. After the soy protein material containing extract is separated from the insolubles, the extract is heat treated, optionally sheared, held at elevated temperatures, cooled, and dried as described above to produce a soy protein isolate composition in accordance with the present invention.

It is preferred to produce a soy protein isolate composition from an alcohol washed soy protein material that has not been dried prior to use in the process of the present invention. Specifically, it is preferred to alcohol wash soy flour, soy flakes, soy grit, or soy meal to form the alcohol washed soy protein concentrate as the first step in producing a soy protein isolate composition of the present invention instead of using a commercially available alcohol washed soy protein concentrate powder that has been dried. Alcohol washed soy protein concentrates that have been dried after being washed with alcohol have decreased soy protein solubility in aqueous solutions relative to alcohol washed soy protein concentrates that have not been dried that are then further processed. In the separation of the soy protein from insoluble fiber to form a protein extract in the production of a soy protein isolate, it is desirable to have maximum soy protein solubility in order to reduce the amount of soy protein lost with the insoluble fraction.

Compositions

The soy protein material composition of the present invention has a high lard gel strength, a high uncooked emulsification strength, and a high cooked emulsification strength. The soy protein material composition also has a very low ash content. The soy protein material of the present invention has a lard gel strength of at least 560 grams, and more preferably has a lard gel strength of at least 575 grams. In a most preferred embodiment, the soy protein material composition of the present invention has a lard gel strength of at least 600 grams. The soy protein material composition of the present invention also has an uncooked emulsification strength of at least 190 grams, and more preferably of at least 225 grams. The soy protein material composition of the present invention further has a cooked emulsification strength of at least 275 grams, and more preferably of at least 300 grams. The ash content of the soy protein material composition of the present invention is at most 4.5 wt. % on a moisture free basis, more preferably at most 3.5 wt. % on a moisture free basis, and most preferably at most 3.0 wt. % on a moisture free basis.

The soy protein concentrate composition has the above lard gel strength, uncooked emulsification strength, cooked emulsification strength, and ash content characteristics and further has a soy protein content of from 65% to 90% by weight on a moisture free basis, and more preferably has a protein content of from 75% to 85% by weight on a moisture free basis.

The soy protein isolate composition has the above lard gel strength, uncooked emulsification strength, cooked emulsification strength, and ash content characteristics, and further has a soy protein content of at least 90% by weight on a moisture free basis.

Foods Containing the Functional Food Ingredient

The soy protein material composition of the present invention is useful in numerous food applications to provide thickening, emulsification, and structural properties to foods. The soy protein material composition may be used in dips, soups, gravies, cereal products, dairy products, tuna products, breads, cakes, macaroni, confections, whipped toppings, baked goods, meat analogs, whole muscle meat products, beef meat products, pork meat products, poultry products, seafood products, and many other applications.

To use the soy protein material composition in a food application, the soy protein material composition—having at least one physical property selected from the group consisting of a lard gel strength of at least 560.0 grams, an uncooked emulsification strength of at least 190.0 grams, and a cooked emulsification strength of at least 275.0 grams—is combined and blended with at least one food ingredient. The food ingredient(s) is/are selected based upon the desired food product. Food ingredients that may be used with the soy protein material composition of the present invention include, for example: emulsified meats; soup stock for producing soups; dairy ingredients, including cultured dairy products; and bread ingredients.

A particularly preferred application in which the soy protein material composition of the present invention is used is in emulsified meats. The soy protein material composition may be used in emulsified meats to provide structure to the emulsified meat, which gives the emulsified meat a firm bite and a meaty texture. The soy protein material composition also decreases cooking loss of moisture from the emulsified meat by readily absorbing water, and prevents “fatting out” of the fat in the meat so the cooked meat is juicier.

The meat material used to for a meat emulsion in combination with the soy protein material composition of the present invention is preferably a meat useful for forming sausages, frankfurters, or other meat products which are formed by filling a casing with a meat material, or can be a meat which is useful in ground meat applications such as hamburgers, meat loaf and minced meat products. Particularly preferred meat materials used in combination with the soy protein material composition include mechanically deboned meat from chicken, beef, and pork; pork trimmings; beef trimmings; pork backfat, and seafood.

A meat emulsion containing a meat material and the soy protein material composition contains quantities of each which are selected to provide the meat emulsion with desirable meat-like characteristics, especially a firm texture and a firm bite. Preferably the soy protein material composition is present in the meat emulsion in an amount of from about 1% to about 30%, by weight, more preferably from about 3% to about 20%, by weight. Preferably the meat material is present in the meat emulsion in an amount of from about 35% to about 70%, by weight, more preferably from about 40% to about 60%, by weight. The meat emulsion also contains water, which is preferably present in an amount of from about 25% to about 55%, by weight, and more preferably from about 30% to about 40%, by weight.

The meat emulsion may also contain other ingredients that provide preservative, flavoring, or coloration qualities to the meat emulsion. For example, the meat emulsion may contain salt, preferably from about 1% to about 4% by weight; spices, preferably from about 0.01% to about 3% by weight; and preservatives such as nitrates, preferably from about 0.01 to about 0.5% by weight.

In addition to the description above, soy protein concentrates having a soy protein content of greater than 65% and less than 90% soy protein, or greater than 75% and less than 90% protein content by weight on a moisture free basis, prepared in accordance with the present invention, have been found to have very low levels of various volatile compounds, which can result in soy protein concentrates having various undesirable off-flavors. These off-flavors can reduce the commercial success of the soy protein concentrates. Specifically, the soy protein concentrates prepared in accordance with the present invention have very low levels of at least one, or at least two, or at least three, or at least four, or at least five, or at least six, or even all seven of the following volatile compounds: (1) 3-methyl butanal; (2) pentanal; (3) hexanal; (4) 1-octen-3-ol; (5) 2-pentyl furan; (6) (E) 3-octen-2-one; and (7) (E) 2-octenal.

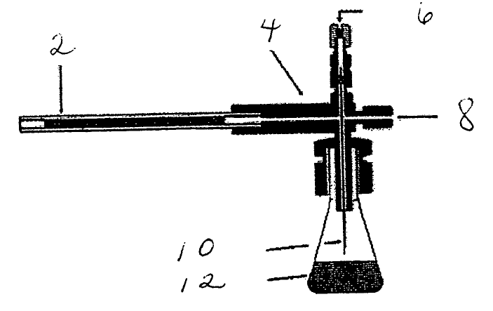

The amount of these volatiles in the soy protein concentrates produced in accordance with the present invention can be measured using Dynamic Headspace (DHS) sampling with Gas-Chromatography-Mass Spectrometry (GC-MS) analysis. Specifically, GC-MS headspace analysis is an objective method for determining volatile constituents produced by a soy protein concentrate by analyzing the vapor phase. A suitable headspace apparatus is shown in FIG. 1, and includes a desorption tube 2, a purge head 4, sparge gas inlet 6, dry purge gas inlet 8, sparge needle 10, and sample 12.

The temperature control of the sample 12 being analyzed in the headspace apparatus is maintained by the use of water jacketing. A 45° C. circulating water bath is connected via tygon tubing to a jacketed beaker large enough to hold the sample vessel, a 50-milliliter Erlenmeyer flask with a 24/40 ground glass joint (Kontes part 617000-0124). The jacketed beaker, containing water, sits on a digitally controlled stir plate with a built-in-timer (VWR Model 565 part 14217-602). A teflon purge head adapter (Scientific Instrument Services (SIS) part 164372) is fit to the Erlenmeyer flask, with a tube style purge head (SIS part 783009) fitted to the adapter. The purge head 4 also contains a sparging needle 10 adjusted such that the tip is 3 plus or minus 1 millimeter above the sample slurry meniscus and directs nitrogen extracting gas (99.9999% pure) toward the surface of the sample 12. Nitrogen gas is obtained from the 60 psig house GC manifold system via a toggle valve and step-down regulator set at 20 psig. A tee coupling directs gas to two digital mass flow controllers (Aalborg part GFC171). The desorption tube 2 is attached to the purge head during sample collection.

To use GC-MS headspace analysis for a concentrate, 6 grams plus or minus 0.005 grams of a soy protein concentrate sample to be analyzed is weighed in a weigh boat. Ninety-five milliliters plus or minus 0.1 milliliters of reverse-osmosis water, available as Milli-Q from Millipore (Billerica, Mass.), is then measured into a graduated cylinder. The water is then transferred into a small (250 milliliters) Waring blender cup. The soy protein concentrate sample is added into the blender. The sample and water are blended at a minimum blending speed for a period of about 1 minute to achieve a good dispersion. The sample slurry is then transferred from the blender cup into an amber bottle. The amber bottle is sealed with a teflon lined screw cap and stored for a period of from about 14 hours to about 30 hours under refrigeration (35° F.-40° F.) to allow the volatiles to establish equilibrium between the soy protein, the aqueous phase, and the headspace. Prior to analysis, the sample bottle is warmed to room temperature by room equilibration or with warm water and stirring.

An internal standard solution is prepared from 4-heptanone (density 0.817 g/ml), available from Aldrich Chemical Co. (St. Louis, Mo.). To prepare the internal standard solution, 10.0 microliters of 4-heptanone is first added to reverse osmosis water in a 100-milliliter volumetric flask using a 10-microliter gas tight syringe. The flask is then made to volume with reverse osmosis water. Twelve milliliters of this solution is then added to a 100-milliliter flask which is made to volume with reverse osmosis water to obtain the internal standard stock solution. To a 20.0 gram sample of soy protein slurry, is added 0.10 milliliters of the internal standard stock solution to obtain a concentration of 49 ppb 4-heptanone.

After the soy protein slurry and internal standard solution are prepared, a sample extraction of the slurry is conducted. To extract the sample, a clean sample collection tube is attached (4 mm i.d. silco-treated stainless steel desorption tube, available as part 786002 from Scientific Instrument Services (SIS) (Ringoes, N.J., packed with 280 milligrams of 60/80 mesh Tenax-GR sorbent (SIS part 979401), held in place at each end with a small plug of silanized glass wool (Supelco part 2-0411))) to a headspace apparatus. Then, an octagonal stir bar (1×⅜″) is added to a 50-milliliter Erlenmeyer flask and 20.00 grams plus or minus 0.02 grams of sample slurry, which has been warmed to room temperature, is added into the flask. Additionally, 7.5 grams plus or minus 0.1 grams of analytical grade sodium chloride is added to the flask. So as not to create foam or wet flask sides or neck joint, the slurry is transferred with a pipette and the stir bar mixer is not activated at this time. 0.10 milliliters of the internal standard solution is then pipetted into the flask.

Immediately after adding the internal standard solution, a purge head 4 is placed firmly onto the Erlenmeyer flask to minimize any escape of the sample volatiles. The tip of the sparging needle 10 should be 3 plus or minus 1 millimeter above the sample slurry meniscus. The entire assembly is then placed into a water filled jacketed beaker, clamped in place, and attached to the two nitrogen line fittings. Without waiting for any temperature equilibration, the nitrogen line toggle valve is opened to start the extraction by firmly holding the purge head assemble in the Erlenmeyer flask neck joint (to prevent popping out by pressure surge). The stir plate is energized to produce 200 rpm The top of the jacketed beaker is enclosed with aluminum foil to retain heat. The stirring slurry surface should contain little or no foam to facilitate maximum volatiles migration from liquid into headspace. Extraction is carried out for a period of about 45 plus or minus 0.1 minutes using a 50 milliliters/minute nitrogen flow through the sparging needle 10. Simultaneously, diluting nitrogen gas (dry purge gas) passes through the top of the purge head 4 at a flow rate of 51 milliliters/minute to help flush water vapor through the desorption tube 2. After 45 minutes, the desorption tube 2 and cap are unscrewed and held at room temperature for GC-MS analysis.

To begin the GC-MS analysis, a desorption tube needle (SIS part #786035), containing a vespel seal (SIS part #786018), is attached to the sample inlet end of the desorption tube 2 that contains the purged volatiles. To the other end of the desorption tube 2, the autodesorb connecting tube (SIS part #786009) is attached. The assembly is placed into one of the twelve positions in the SIS Automated Short Path Thermal Desorption Injection System. Before beginning desorption, the desorption conditions are set as follows: purge: 1.00 minute, inject: 1.00 minutes, desorb: 5.00 minutes at 280° C., heat delay: 0.5 minutes, start GC: 7.5 minutes, Cryo trap:−150° C., with the liquid nitrogen source attached, Cryo heat: 283° C., and desorb temp: 280° C. Additionally, the pressures of the gas manifold lines should be set as follows: helium 60 plus or minus 1 psig and nitrogen: 60 plus or minus 1 psig, with a step-down to 20 psig during sample extraction. The GC-MS analysis is initiated with the ChemStation software that also initiates the SIS desorber system.

GC-MS analysis may be conducted using an Agilent® 6890N GC equipped with a 7973 MSD detector and Agilent® ChemStation software Version C.00.00 (Palo Alto, Calif.). Attached to the GC is a Scientific Instrument Services (SIS) AutoDesorb System with SIS controlling software Version 1.0.3. The conditions of the GC apparatus are set as follows: the injector contains SIS injection port liner SIPL 10 and its temperature is 280° C., with helium carrier gas at 1.1 milliliters/minute at split ratio 4.0:1; the column is an Agilent® Ultra 1-50 meters×0.32 millimeters, with 0.52 microns stationary phase (available as part 19091A-115 from Agilent); and the temperature is set initially at 35° C. and held for 1 minute, then raised 4° C./minute to 180° C., and then again raised 30.0° C./minute to 270° C. and held for 3 minutes. The conditions of the MS apparatus are set as follows: the transfer tube is 280° C.; source is 230° C.; vacuum is max 2×10-5 Torr, mass range is 27-350 a.m.u.; and scan frequency is at 3 Hz.

To analyze the data produced in the GC-MS analysis, the raw peak area obtained by extracted SIM (selected ion monitoring) for the selected target ion was multiplied by a conversion factor. The conversion factors are obtained by dividing the combined abundance of the 10 largest ions in the spectrum of the authentic standard by the abundance of the target ion. The conversion factor for the internal standard peak area is determined with an authentic sample of 4-heptanone run on the mass spectrometer used for these analyses. The conversion factors for the target analytes are calculated from the spectra present in the NIST mass spectral library. The resulting peak area is representative of the total mass spectral response for that compound. This value was divided by the peak area for the internal standard and multiplied by 49, since the internal standard concentration is 49 ppb, to yield the concentration in ppb for the target analyte.

The list of target compounds, with retention time (in minutes), quantitation ion and conversion factor for use in converting the extracted SIN peak area to total ion peak area are shown in Table 1.

TABLE 1

| | Retention | Quantitation | |
|---|---|---|---|
| Target Compound | Time (min.) | Ion | Conversion Factor |
| 3-methyl butanal | 6.2 | 58 | 10.84 |
| Pentanal | 7.2 | 44 | 4.14 |
| Hexanal | 10.5 | 56 | 5.70 |
| 1-octen-3-ol | 17.7 | 57 | 2.13 |
| 2-pentyl furan | 18.0 | 81 | 1.90 |
| (E) 3-octen-2-one | 19.7 | 111 | 6.30 |
| (E) 2-octenal | 20.4 | 70 | 9.20 |
| 4-heptanone (Internal | 13.5 | 114 | 14.72 |
| Standard) | | | |

In one embodiment of the present invention, the soy protein concentrate comprises less than about 0.5 ppb 3-methyl butanal, suitably less than about 0.4 ppb 3-methyl butanal, and even more suitably less than about 0.3 ppb 3-methyl butanal.

In another embodiment of the present invention, the soy protein concentrate comprises less than about 10 ppb pentanal, suitably less than about 8 ppb pentanal, suitably less than about 6 ppb pentanal, and even more suitably less than about 4 ppb pentanal.

In another embodiment of the present invention, the soy protein concentrate comprises less than about 25 ppb hexanal, suitably less than about 20 ppb hexanal, suitably less than about 18 ppb hexanal, and even more suitably less than about 15 ppb hexanal.

In yet another embodiment of the present invention, the soy protein concentrate comprises less than about 1ppb 1-octen-3-ol, suitably less than about 0.50 ppb 1-octen-3-ol, and even more suitably less than about 0.20 ppb 1-octen-3-ol.

In yet another embodiment of the present invention, the soy protein concentrate comprises less than about 1 ppb 2-pentyl furan, suitably less than about 0.8 ppb 2-pentyl furan, and even more suitably less than about 0.5 ppb 2-pentyl furan.

In yet another embodiment, the soy protein concentrate comprises less than about 2.5 ppb (E) 3-octen-2-one, suitably less than about 1.5 ppb (E) 3-octen-2-one, even more suitably less than about 1.25 ppb (E) 3-octen-2-one, and even more suitably less than about 1 ppb (E) 3-octen-2-one.

In still another embodiment, the soy protein concentrate comprises less than about 0.2 ppb (E) 2-octenal, suitably less than about 0.15 ppb (E) 2-octenal, and even more suitably less than about 0.1 ppb (E) 2-octenal.

The following non-limiting examples illustrate various features and characteristics of the present invention which are not to be construed as limited thereto.

### EXAMPLE 1

A composition of the present invention is prepared by washing an alcohol washed soy protein concentrate with an aqueous wash having a pH slightly above the isoelectric point of soy protein utilizing a combination of centrifugation and ultrafiltration, then cooking and shearing the washed protein material at a pH of 7.2. About 50.0 lbs of Procon® 2000 (a commercially available traditional alcohol washed soy protein concentrate) is mixed with 70.0 gallons of water that is preheated to 120° F. (49° C.). The pH of the mixture is adjusted to about 5.1 using hydrochloric acid and the mixing is continued for another 20 minutes. The slurry is centrifuged in a decanting centrifuge at feed rate of 2 gallons per minute. The centrifuge cake is diluted to about 8.0 wt. % solids using water preheated to 120° F. (49° C.). The slurry is again centrifuged in a decanting centrifuge at feed rate of 2 gallons per minute. The supernatant (liquor) from the two centrifugations is mixed and transferred to the feed tank of the membrane system. The liquor is ultrafiltered using a 10,000 molecular weight cutoff (MWCO) spiral-wound membrane to remove about 90.0 wt. % of the feed volume as permeate. The retentate from the membrane system and the cake from the second centrifugation are mixed, and additional water is added to dilute the slurry to about 13.0 wt. % solids. The pH of the slurry is adjusted to about 7.2 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 3 minutes and then flashed into a flash cooler with 15″ of vacuum. The flash cooled slurry is spray dried. The dried product is analyzed to determine the ash content thereof, and lard gel strength, protein content, and NSI are determined according to the procedures described herein. The results of the analysis are shown in TABLE 1.

TABLE 1
Composition of product derived from the method of EXAMPLE 1

| | |
|---|---|
| Lard Gel Strength, g | 595.0 |
| Protein (wt. %, mfb) | 76.32 |
| Ash (wt. %, mfb) | 3.04 |
| Calcium (wt. %, mfb) | 0.37 |
| Potassium (wt. %, mfb) | 0.33 |
| Magnesium (wt. %, mfb) | 0.12 |
| Sodium (wt. %, mfb) | 0.75 |
| Nitrogen Solubility Index, NSI (%) | 55.7 |

### EXAMPLE 2

A composition of the present invention is prepared by washing an alcohol washed soy protein concentrate with an aqueous wash having a pH slightly above the isoelectric point of soy protein utilizing centrifugation only, then cooking and shearing the washed protein material at a pH of 7.2. About 50.0 lbs of Procon® 2000 (a commercially available traditional alcohol washed soy protein concentrate) is mixed with 70.0 gallons of water preheated to 120° F. (49° C.). The pH of the mixture is adjusted to about 5.1 using hydrochloric acid and the mixing is continued for another 20 minutes. The slurry is centrifuged in a decanting centrifuge at feed rate of 2 gallons per minute. The centrifuge cake is diluted to about 8.0 wt. % solids using water preheated to 120° F. (49° C.). The slurry is again centrifuged in a decanting centrifuge at feed rate of 2 gallons per minute. The supernatant (liquor) from the two centrifugations is discarded. The cake from the second centrifugation is diluted with water to about 13.0 wt. % solids. The pH of the slurry is adjusted to about 7.2 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 3 minutes and then flashed into a flash cooler with 15″ of vacuum. The flash cooled slurry is spray dried. The dried product is analyzed to determine the ash content thereof, and lard gel strength, protein content and NSI are determined according to the procedures described herein. The results of the analysis are shown in TABLE 2.

TABLE 2
Composition of product derived from the method of EXAMPLE 2

| | |
|---|---|
| Lard Gel Strength, g | 607.0 |
| Protein (wt. %, mfb) | 79.81 |
| Ash (wt. %, mfb) | 3.27 |
| Calcium (wt. %, mfb) | 0.27 |
| Potassium (wt. %, mfb) | 0.40 |
| Magnesium (wt. %, mfb) | 0.08 |
| Sodium (wt. %, mfb) | 0.74 |
| Nitrogen Solubility Index, NSI (%) | 46.7 |

### EXAMPLE 3

A composition of the present invention is prepared by washing an alcohol washed soy protein concentrate with an aqueous wash having a pH slightly above the isoelectric point of soy protein utilizing centrifugation only, then cooking and shearing the washed protein material at a pH of 7.5. About 50.0 lbs (22.7 kg) of Procon® 2000 (a commercially available traditional alcohol washed soy protein concentrate) is mixed with 70.0 gallons of water preheated to 120° F. (49° C.). The pH of the mixture is adjusted to about 5.0 using hydrochloric acid and the mixing is continued for another 20 minutes. The slurry is again centrifuged in a decanting centrifuge at feed rate of 2 gallons per minute. The centrifuge cake is diluted to about 8.0 wt. % solids using water preheated to 120° F. (49° C.). The slurry is centrifuged in a decanting centrifuge at feed rate of 2 gallons per minute. The supernatant (liquor) from the two centrifugations is discarded. The cake from the second centrifugation is diluted with water to about 12.5 wt. % solids. The pH of the slurry is adjusted to about 7.5 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 3 minutes and then flashed into a flash cooler with 15″ of vacuum. The flash cooled slurry is spray dried. The dried product is analyzed to determine the ash content thereof, and lard gel strength, protein content, and NSI are determined according to the procedures described herein. The results of the analysis are shown in TABLE 3.

TABLE 3
Composition of product derived from the method of EXAMPLE 3

| | |
|---|---|
| Lard Gel Strength, g | 571.0 |
| Protein (wt. %, mfb) | 79.06 |
| Ash (wt. %, mfb) | 3.87 |
| Calcium (wt. %, mfb) | 0.28 |
| Potassium (wt. %, mfb) | 0.16 |
| Magnesium (wt. %, mfb) | 0.08 |
| Sodium (wt. %, mfb) | 1.14 |
| Nitrogen Solubility Index, NSI (%) | 66.3 |

### EXAMPLE 4

A composition of the present invention is prepared by washing an alcohol washed soy protein concentrate with an aqueous wash having a pH at the isoelectric point of soy protein utilizing centrifugation only, then cooking the washed protein material at a pH of 7.5 without subjecting the washed protein material to shear. About 50.0 lbs (22.7 kg) of Procon® 2000 (a commercially available traditional alcohol washed soy protein concentrate) is mixed with 70.0 gallons of water preheated to 133° F. (56° C.). The pH of the mixture is adjusted to about 4.5 using hydrochloric acid and the mixing is continued for another 20 minutes. The slurry is centrifuged in a decanting centrifuge at feed rate of 2 gallons per minute. The centrifuge cake is diluted to about 8.0 wt. % solids using water preheated to 133° F. (56° C.). The slurry is again centrifuged in a decanting centrifuge at feed rate of 2 gallons per minute. The supernatant (liquor) from the two centrifugations is discarded. The cake from the second centrifugation is diluted with water to about 12.5 wt. % solids. The pH of the slurry is adjusted to about 7.5 using sodium hydroxide. This slurry is then jet cooked to a temperature of about 300° F. (149° C.), held for 3 minutes and then flashed into a flash cooler with 15″ of vacuum. The flash cooled slurry is spray dried. The dried product is analyzed to determine the ash content thereof, and lard gel strength, protein content, and NSI are determined according to the procedures described herein. The results of the analysis are shown in TABLE 4.

TABLE 4
Composition of product derived from the method of EXAMPLE 4

| | |
|---|---|
| Lard Gel Strength, g | 591.0 |
| Protein (wt. %, mfb) | 77.75 |
| Ash (wt. %, mfb) | 4.02 |
| Calcium (wt. %, mfb) | 0.29 |
| Potassium (wt. %, mfb) | 0.17 |
| Magnesium (wt. %, mfb) | 0.09 |
| Sodium (wt. %, mfb) | 1.34 |
| Nitrogen Solubility Index, NSI (%) | 58.7 |

### EXAMPLE 5

A composition of the present invention is prepared by washing an alcohol washed soy protein concentrate with an aqueous wash having a pH at the isoelectric point of soy protein utilizing centrifugation only, then cooking and shearing the washed protein material at a pH of 7.5. About 50.0 lbs (22.7 kg) of Procon® 2000 (a commercially available traditional alcohol washed soy protein concentrate) is mixed with 70.0 gallons of water preheated to 133° F. (56° C.). The pH of the mixture is adjusted to about 4.5 using hydrochloric acid and the mixing is continued for another 20 minutes. The slurry is centrifuged in a decanting centrifuge at feed rate of 2 gallons per minute. The centrifuge cake is diluted to about 8.0 wt. % solids using water preheated to 133° F. (56° C.). The slurry is again centrifuged in a decanting centrifuge at feed rate of 2 gallons per minute. The supernatant (liquor) from the two centrifugations is discarded. The cake from the second centrifugation is diluted with water to about 12.5 wt. % solids. The pH of the slurry is adjusted to about 7.5 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 3 minutes and then flashed into a flash cooler with 15″ of vacuum. The flash cooled slurry is spray dried. The dried product is analyzed to determine the ash content thereof, and lard gel strength, protein content, and NSI are determined according to the procedures described herein. The results of the analysis are shown in TABLE 5.

TABLE 5
Composition of product derived from the method of EXAMPLE 5

| | |
|---|---|
| Lard Gel Strength, g | 666.0 |
| Protein (wt. %, mfb) | 77.56 |
| Ash (wt. %, mfb) | 4.44 |
| Calcium (wt. %, mfb) | 0.30 |
| Potassium (wt. %, mfb) | 0.12 |
| Magnesium (wt. %, mfb) | 0.09 |
| Sodium (wt. %, mfb) | 1.46 |
| Nitrogen Solubility Index, NSI (%) | 59.8 |

### EXAMPLE 6

A composition of the present invention is prepared by washing an alcohol washed soy protein concentrate with an aqueous wash having a pH slightly above the isoelectric point of soy protein utilizing centrifugation only, then cooking and shearing the washed protein material at a pH of 7.5. About 50.0 lbs (22.7 kg) of Procon® 2000 (a commercially available traditional alcohol washed soy protein concentrate) is mixed with 70.0 gallons of water preheated to 133° F. (56° C.). The pH of the mixture is adjusted to about 5.0 using hydrochloric acid and the mixing is continued for another 20 minutes. The slurry is centrifuged in a decanting centrifuge at feed rate of 2 gallons per minute. The centrifuge cake is diluted to about 8.0 wt. % solids using water preheated to 133° F. (56° C.). The slurry is again centrifuged in a decanting centrifuge at feed rate of 2 gallons per minute. The supernatant (liquor) from the two centrifugations is discarded. The cake from the second centrifugation is diluted with water to about 12.5 wt. % solids. The pH of the slurry is adjusted to about 7.5 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 3 minutes and then flashed into a flash cooler with 15″ of vacuum. The flash cooled slurry is spray dried. The dried product is analyzed to determine the ash content thereof, and lard gel strength, protein content, and NSI are determined according to the procedure described herein. The results of the analysis are shown in TABLE 6.

TABLE 6
Composition of product derived from the method of EXAMPLE 6

| | |
|---|---|
| Lard Gel Strength, g | 633.0 |
| Protein (wt. %, mfb) | 79.81 |
| Ash (wt. %, mfb) | 3.27 |
| Calcium (wt. %, mfb) | 0.31 |
| Potassium (wt. %, mfb) | 0.24 |
| Magnesium (wt. %, mfb) | 0.09 |
| Sodium (wt. %, mfb) | 1.07 |
| Nitrogen Solubility Index, NSI (%) | 65.1 |

### EXAMPLE 7

A composition of the present invention is prepared by washing an alcohol washed soy protein concentrate with an aqueous wash having a pH at the isoelectric point of soy protein utilizing ultrafiltration only, then cooking and shearing the washed protein material at a pH of 7.5. About 50.0 lbs (22.7 kg) of Procon® 2000 (a commercially available traditional alcohol washed soy protein concentrate) is mixed with 240.0 gallons of water preheated to 120° F. (49° C.). The pH of the mixture is adjusted to about 4.5 using hydrochloric acid and the mixing is continued for another 20 minutes. The slurry is transferred to a membrane feed tank through a 20-mesh strainer. The slurry is fed to an ultrafiltration membrane system containing two tubular membranes, both of 50,000 MWCO. The temperature of the suspension is maintained at about 48.9° C. (120° F.) during membrane processing. About 85.0 wt. % of the original feed volume added to the membrane feed tank is removed as permeate. The pH of the retentate from the membrane system is adjusted to about 7.5 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 60 seconds and then flashed into a flash cooler with 15″ of vacuum. The flash cooled slurry is spray dried. The dried product was analyzed to determine the ash content thereof, and lard gel strength, protein content, and NSI are determined according to the procedures described herein. The results of the analysis are shown in TABLE 7.

TABLE 7
Composition of product derived from the method of EXAMPLE 7

| | |
|---|---|
| Lard Gel Strength, g | 579.0 |
| Protein (wt. %, mfb) | 77.75 |
| Ash (wt. %, mfb) | 3.08 |
| Calcium (wt. %, mfb) | 0.29 |
| Potassium (wt. %, mfb) | 0.38 |
| Magnesium (wt. %, mfb) | 0.11 |
| Sodium (wt. %, mfb) | 1.35 |
| Nitrogen Solubility Index, NSI (%) | 54.3 |

### EXAMPLE 8

A composition of the present invention is prepared by washing an alcohol washed soy protein concentrate with an aqueous wash having a pH slightly above the isoelectric point of soy protein utilizing ultrafiltration only, then cooking and shearing the washed protein material at a pH of 7.5. About 50.0 lbs (22.7 kg) of Procon® 2000 (a commercially available traditional alcohol washed soy protein concentrate) is mixed with 240.0 gallons of water preheated to 120° F. (49° C.). The pH of the mixture is adjusted to about 5.0 using hydrochloric acid and the mixing is continued for another 20 minutes. The slurry is transferred to a membrane feed tank through a 20-mesh strainer. The slurry is fed to an ultrafiltration membrane system containing two tubular membranes, both of 50,000 MWCO. The temperature of the suspension is maintained at about 48.9° C. (120° F.) during membrane processing. About 80.0 wt. % of the original feed volume added to the membrane feed tank is removed as permeate. The pH of the retentate from the membrane system is adjusted to about 7.5 using sodium hydroxide. This slurry is then jet cooked to a temperature of about 300° F. (149° C.), passed through a shear pump (Dispax Reactor Model DR 3-6/6A equipped with fine, fine and superfine generators in series, operating at 8000 rpm, IKA Works, Wilmington, N.C.), held for 60 seconds and then flashed into a flash cooler with 15″ of vacuum. The flash cooled slurry is spray dried. The dried product is analyzed to determine the ash content thereof, and lard gel strength, protein content, and NSI are determined according to the procedures described herein. The results of the analysis are shown in TABLE 8.

TABLE 8
Composition of product derived from the method of EXAMPLE 8

| | |
|---|---|
| Lard Gel Strength, g | 677.0 |
| Protein (wt. %, mfb) | 78.13 |
| Ash (wt. %, mfb) | 2.48 |
| Calcium (wt. %, mfb) | 0.31 |
| Potassium (wt. %, mfb) | 0.44 |
| Magnesium (wt. %, mfb) | 0.12 |
| Sodium (wt. %, mfb) | 1.07 |
| Nitrogen Solubility Index, NSI (%) | 63.9 |

### EXAMPLE 9

In a continuous process trial, Danpro™ H (a commercially available traditional alcohol washed soy protein concentrate) is hydrated and mixed with hot water to achieve 9% solids while maintaining temperature at 185° F. (85° C.). The pH of the mixture is adjusted to about 5.2 using sulfuric acid while mixing is continued. The slurry is centrifuged in a counter-current flow using two separation steps using decanting centrifuges. The centrifuge cake is diluted to about 12.0 wt. % solids and the pH of the slurry is adjusted to about 7.5 using sodium hydroxide. This slurry is then jet cooked to a temperature of about 300° F. (149° C.), held for 15 seconds and then flashed into a flash cooler to a temperature of 185° F (85° C.). The flash cooled slurry is spray dried. The spray dried powder is lecithinated with 0.6% of lecithin-oil mixture (1:1 ratio) to enhance the flowability of the powder. The uncooked and cooked emulsification strengths of the spray dried powder are measured according to the procedure described herein. The results of the analysis (average of 14 samples taken during the trial, and the maximum and minimum values of the samples) are shown in TABLE 9.

TABLE 9
Composition of product derived from the method of EXAMPLE 9

| | Avg. | Max | Min |
|---|---|---|---|
| Uncooked Emulsification Strength (g) | 225.9 | 260 | 190 |
| Cooked Emulsification Strength (g) | 294.4 | 391 | 252 |

### EXAMPLE 10

In a continuous process trial, Procon® 2000 (a commercially available traditional alcohol washed soy protein concentrate) is initially hydrated and mixed with hot water to achieve 9% solids. The pH of the mixture is adjusted to about 4.5 using hydrochloric acid while mixing is continued. The slurry is centrifuged at 135° F. (57° C.) at flow rate of 105 pounds per minute in a counter-current flow using two separation steps using P-3400 decanting centrifuges. The centrifuge cake from first separation is diluted using water at 90° F. (32° C.), where the flow rate of water addition is 9.6 times the weight of Procon® 2000. The supernatant (liquor) from the first centrifugation is discarded. The supernatant (liquor) from the second centrifugation is recycled to hydrate the Procon® 2000 in the continuous process. The cake from the second centrifugation is diluted with water to about 13.0 wt. % solids. The pH of the slurry is adjusted to about 7.2 using sodium hydroxide. This slurry is then jet cooked to a temperature of about 300° F. (149° C.), held for 15 seconds and then flashed into a flash cooler to a temperature of about 180° F. (82° C.). The flash cooled slurry is spray dried. The spray dried powder is used to determine lard gel strength, uncooked emulsification strength and cooked emulsification strength according to the procedure described herein.

The spray dried powder has a lard gel strength of 622 g, an uncooked emulsification strength of 260 g, and a cooked emulsification strength of 391 g.

### EXAMPLE 11

The trial of Example 10 is repeated except that the slurry is jet cooked at a temperature of about 275° F. (135° C.).

The spray dried powder has a lard gel strength of 617 g, an uncooked emulsification strength of 213 g, and a cooked emulsification strength of 287 g.

### EXAMPLE 12

The trial of Example 10 is repeated except that the jet cooked slurry is held for 30 seconds prior to flash cooling.

The spray dried powder has a lard gel strength of 606 g, an uncooked emulsification strength of 196 g, and a cooked emulsification strength of 300 g.

### EXAMPLE 13

The present novel soy protein material is utilized in the preparation of comminuted meat products having reduced meat protein inclusion compared to traditional comminuted meat products. A pasteurized comminuted meat product is formulated from the ingredients listed in TABLE 10.

TABLE 10
Ingredients for Novel Meat Product of Example 13

| Ingredients | Formula (wt. %) |
|---|---|
| Mechanically Separated Turkey | 51.000 |
| (20% Fat) | |
| Pork Back Fat (85% Fat) | 11.500 |
| Water/Ice | 27.665 |
| Novel Soy Protein Concentrate | 7.000 |
| Salt | 1.960 |
| Sodium Tripolyphosphate | 0.500 |
| Cure Salt (6.25% sodium nitrite) | 0.320 |
| Sodium Erythorbate | 0.055 |
| Total | 100.000 |

The formulation is calculated so that the final comminuted meat product will have ≦7.0 wt. % meat protein, ≧12.0 wt. % total protein, ≧20.0 wt. % total fat, and ≧62.0 wt. % moisture. The controlled composition of these attributes is designed to verify the ability of the present novel soy protein concentrate to bind fat and moisture as well as contribute texture to a final cooked meat product.

The meat components are ground into ½″ pieces prior to processing. The mechanically separated turkey, salt, cure salt and sodium tripolyphosphate are chopped together in a vacuum bowl chopper at 1500 rpm (Meissner 35L, RMF, Kansas City, Mo.) for 2 minutes to facilitate meat protein extraction. The water/ice mixture along with the present novel soy protein concentrate is added and chopped for 2 minutes at 2000 rpm to insure full hydration of the dry protein concentrate. The pork back fat and erythorbate are then added and chopped for 4 revolutions of the bowl to uniformly disperse these final ingredients. Once uniform dispersion is achieved, vacuum is applied to the bowl (≧25 mm Hg) with an additional 4 minutes of chopping at 3850 rpm. Final mixture temperature is 13° C. to 16° C. (55° to 60° F.). The mixture is then removed from the bowl chopper and vacuum stuffed in 55 mm moisture impermeable casings with clip enclosures for end sealing. The encased mixture is then heat processed to 74° C. (165° F.). The cooked meat product is then cooled at room temperature.

The meat formulation can be further modified with more or less meat protein and varying novel protein inclusion levels to determine the optimum texture contribution as well as the optimum meat protein replacement for further application development as may be desired for specific applications in the processed meat industry.

### EXAMPLE 14

In this Example, the soy protein concentrate prepared in Example 9 (protein content greater than 75% and less than 90% by weight on a moisture free basis), the commercially available soy protein concentrate PROMINE® 3275 (The Solae Company, St. Louis, Mo.) (soy protein content about 68%) are analyzed by Gas Chromatography/Mass Spectroscopy (GC/MS) as described above for the content (measured in parts per billion) of various volatile compounds known to cause off-flavors in soy protein concentrates. Specifically, the soy protein concentrates were analyzed for 3-methyl butanal, pentanal, hexanal, 1-octen-3-ol, 2-pentyl furan, (E) 3-octen-2-one, and (E) 2-octenal content. The results are shown in Table 11.

TABLE 11

| Volatile Compound | Example 9 Concentrate | PROMINE ® 3275 |
|---|---|---|
| 3-methyl butanal | 0.26 | 0.74 |
| Pentanal | 3.99 | 3.32 |
| Hexanal | 14.28 | 8.68 |
| 1-Octen-3-ol | 0.44 | 0.72 |
| 2-Pentyl Furan | 0.36 | 0.46 |
| (E) 3-octen-2-one | 0.04 | 0.11 |
| (E) 2-Octenal | 0.06 | 0.02 |

As the results in Table 11 indicate, the concentrate as prepared in Example 9 above, while having a high protein content, has a very low level of volatile compounds that can negatively affect taste in food products.

### COMPARATIVE EXAMPLE 1

A soy protein material is prepared according to the process of U.S. Pat. No. 4,234,620 which subjects an alcohol washed protein concentrate to shear without first removing solubles from the alcohol washed protein concentrate with an aqueous acidic wash. About 25 lbs of Procon® 2000 (a commercially available traditional alcohol washed soy protein concentrate) is mixed with 175 lbs of water. About 0.30 lb of 50% sodium hydroxide is added to the slurry. The resulting aqueous slurry has 1000 parts by weight Procon® 2000, 7000 parts by weight water, and 6 parts by weight sodium hydroxide, all expressed on dry solids basis. The slurry is mixed for 20 minutes. The slurry is then jet cooked and passed through a shear pump to provide the shearing action necessary to restructure the protein material. The shear pump is a Dispax Reactor Model DR 3-6/6A (IKA Works, Wilmington, N.C.) equipped with fine, fine and superfine generators in series, operating at 8000 rpm at a flow rate of 5 gallons per minute. The heated sheared slurry is held for 19 seconds at high temperature and then is discharged into a tank at a temperature of about 220° F. (104° C.). The pH of the jet cooked slurry is adjusted to about 6.4 using hydrochloric acid, and then the slurry is spray dried. In the dryer, the inlet temperature is about 450° F. and the outlet temperature is about 200° F. The dried product is analyzed to determine the protein content and ash content as well as its lard gel strength and NSI. The results of the analysis are shown below in Table 15.

TABLE 15
Composition of product derived from method of Comparative Example 1

| | |
|---|---|
| Lard Gel Strength, g | 401.0 |
| Protein (wt. %, mfb) | 72.25 |
| Ash (wt. %, mfb) | 7.28 |
| Calcium (wt. %, mfb) | 0.50 |
| Potassium (wt. %, mfb) | 2.36 |
| Magnesium (wt. %, mfb) | 0.39 |
| Sodium (wt. %, mfb) | 0.85 |
| Nitrogen Solubility Index, NSI (%) | 56.0 |

The lard gel strength of the soy protein material of the present invention, as shown in Examples 1-8 and 10-12, is much greater than that of the material produced in Comparative Example 1.

### COMPARATIVE EXAMPLE 2

The uncooked emulsification strength and cooked emulsification strength of Arcon® S, a commercially available soy protein concentrate, are measured. 14 samples of Arcon® S are analyzed for uncooked and cooked emulsification strengths in accordance with the procedure set forth above in the definitions section. The results of the analysis are shown below in Table 16, where the average, maximum, and minimum measured uncooked and cooked emulsification strengths are reported.

TABLE 16
Emulsification strengths of Arcon ® S

| Arcon ® S | Avg. | Max | Min |
|---|---|---|---|
| Uncooked Emulsification Strength (g) | 122 | 146 | 104 |
| Cooked Emulsification Strength (g) | 239 | 273 | 205 |

The uncooked emulsion strength and cooked emulsion strength of the soy protein material of the present invention, as shown in Examples 9-12, are much greater than those of the material produced in Comparative Example 2.

### COMPARATIVE EXAMPLE 3

The lard gel strength of Arcon® S, a commercially available soy protein concentrate, is measured. 5 samples of Arcon® S are analyzed for lard gel strength in accordance with the procedure set forth above in the definitions section. The results of the analysis are shown below in Table 17, where the average, maximum, and minimum measured lard gel strengths are reported.

TABLE 17
Lard gel strength of Arcon S

| Arcon S | Avg. | Max | Min |
|---|---|---|---|
| Lard Gel Strength (g) | 438 | 540 | 305 |

The lard gel strength of the soy protein material of the present invention, as shown in Examples 1-8 and 10-12, is much greater than that of the material produced in Comparative Example 3.

Additional objects, advantages and other novel features of the invention will become apparent to those skilled in the art upon examination of the foregoing or may be learned with practice of the invention. The foregoing description of preferred embodiments of the invention has been presented for purposes of illustration and description. It is not intended to be exhaustive or to limit the invention to the precise form disclosed. Obvious modifications or variations are possible in light of the above teachings. The embodiments were chosen and described to provide the best illustrations of the principles of the invention and their practical application, thereby enabling one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1-63. (canceled)

64. A soy protein concentrate comprising less than about 10 ppb pentanal, wherein the soy protein concentrate comprises greater than 75% protein and less than 90% protein content by weight on a moisture free basis.

65. The soy protein concentrate as set forth in claim 64 further comprising less than about 10 ppb hexanal.

66. The soy protein concentrate as set forth in claim 65 further comprising less than about 1 ppb 1-octen-3-ol.

67. The soy protein concentrate as set forth in claim 66 further comprising less than about 1 ppb 2-pentyl furan.

68. The soy protein concentrate as set forth in claim 67 further comprising less than about 2.5 ppb (E) 3-octen-2-one.

69. The soy protein concentrate as set forth in claim 68 further comprising less than about 0.2 ppb (E) 2-octenal.

70. The soy protein concentrate as set forth in claim 69 wherein the soy protein concentrate has a lard gel strength of at least 560 grams.

71. A food product comprising the soy protein concentrate of claim 64.

72. The food product of claim 71 selected from the group consisting of dry blended beverages, ready to drink neutral beverages, ready to drink acid beverages, yogurt, food and protein bars, infant formula, emulsified meat, whole muscle meat, and meat analogs.

73. A soy protein concentrate comprising less than about 25 ppb hexanal, wherein the soy protein concentrate comprises greater than 75% protein and less than 90% protein content by weight on a moisture free basis.

74. The soy protein concentrate as set forth in claim 73 further comprising less than about 1 ppb 1-octen-3-ol.

75. The soy protein concentrate as set forth in claim 74 further comprising less than about 1 ppb 2-pentyl furan.

76. The soy protein concentrate as set forth in claim 75 further comprising less than about 2.5 ppb (E) 3-octen-2-one.

77. The soy protein concentrate as set forth in claim 76 further comprising less than about 0.2 ppb (E) 2-octenal.

78. The soy protein concentrate as set forth in claim 77 wherein the soy protein concentrate has a lard gel strength of at least 560 grams.

79. A food product comprising the soy protein concentrate of claim 73.

80. The food product of claim 79 selected from the group consisting of dry blended beverages, ready to drink neutral beverages, ready to drink acid beverages, yogurt, food and protein bars, infant formula, emulsified meat, whole muscle meat, and meat analogs.

81. A soy protein concentrate comprising less than about 2.5 ppb (E) 3-octen-2-one, wherein the soy protein concentrate comprises greater than 75% protein and less than 90% protein content by weight on a moisture free basis.

82. The soy protein concentrate as set forth in claim 81 further comprising less than about 0.2 ppb (E) 2-octenal.

83. The soy protein concentrate as set forth in claim 82 wherein the soy protein concentrate has a lard gel strength of at least 560 grams.

84. A food product comprising the soy protein concentrate of claim 81.

85. The food product of claim 84 selected from the group consisting of dry blended beverages, ready to drink neutral beverages, ready to drink acid beverages, yogurt, food and protein bars, infant formula, emulsified meat, whole muscle meat, and meat analogs.

86. A soy protein concentrate comprising less than about 25 ppb hexanal, wherein the soy protein concentrate comprises greater than 75% protein and less than 90% protein content by weight on a moisture free basis, and wherein the soy protein concentrate is prepared from a method comprising:
slurrying an alcohol washed soy protein material in water;
adjusting the pH of the slurry to an acid pH of less than 6.0;
removing soluble components from the acid pH slurry;
adjusting the pH of the acid pH slurry to above 7.0 after removing soluble components from the acid pH slurry to provide a neutralized slurry; and
subjecting the neutralized slurry to heat treatment at a sufficient temperature and for a sufficient period of time to change the structure of the soy protein material.

87. The soy protein concentrate as set forth in claim 86 further comprising less than about 10 ppb pentanal.

88. The soy protein concentrate as set forth in claim 87 further comprising less than about 10 ppb pentanal.

89. The soy protein concentrate as set forth in claim 88 further comprising less than about 0.5 ppb 3-methylbutanal.

90. The soy protein concentrate as set forth in claim 89 further comprising less than about 1 ppb 1-octen-3-ol.

91. The soy protein concentrate as set forth in claim 90 further comprising less than about 1 ppb 2-pentyl furan.

92. The soy protein concentrate as set forth in claim 91 further comprising less than about 0.2 ppb (E) 2-octenal.

93. A food product comprising the soy protein concentrate of claim 86.

94. The food product of claim 93 selected from the group consisting of dry blended beverages, ready to drink neutral beverages, ready to drink acid beverages, yogurt, food and protein bars, infant formula, emulsified meat, whole muscle meat, and meat analogs.
